(19) United States
(12) Patent Application Publication
(10) Pub. No.: US 2025/0354598 A1
(43) Pub. Date: Nov. 20, 2025

(54) SPRING MECHANISM

(71) Applicant: PANASONIC HOLDINGS CORPORATION, Osaka (JP)

(72) Inventors: Toshiyuki SHIMIZU, Osaka (JP); Jie LIN, Osaka (JP); Koki TANAKA, Osaka (JP); Shota ISHIWATARI, Tokyo (JP)

(21) Appl. No.: 19/282,165

(22) Filed: Jul. 28, 2025

Related U.S. Application Data
(63) Continuation of application No. PCT/JP2023/045943, filed on Dec. 21, 2023.

(30) Foreign Application Priority Data
Jan. 30, 2023 (JP) 2023-012330

(51) Int. Cl. F16F 15/03

(52) U.S. Cl. CPC F16F 15/03; F16F 2230/08; F16F 2230/18; F16F 2232/04; F16F 2238/022

(57) ABSTRACT

A spring mechanism includes: a drive unit; a main body that houses the drive unit; a first structure that is disposed facing a first main surface of the main body and separated from the main body; and at least one first elastic member that has a first main surface side end movably connected to the first main surface and a first structure side end movably connected to the first structure, the at least one first elastic member including a non-circular cross-sectional shape. The first elastic member rotates about a longitudinal axis by driving of the drive unit, thus allowing a repulsive force of the first elastic member with respect to a load component in a direction in which the first structure is pressed against the main body to be variably set.

### FIELD OF INVENTION

The present disclosure relates to a spring mechanism.

### BACKGROUND ART

Patent Literature 1 discloses a bed spring member capable of adjusting rigidity by rotating a support.

However, the spring member disclosed in Patent Literature 1 allows the user to manually rotate the support, and no consideration has been given to a mechanism for simply and precisely adjusting the spring constant by driving of the drive unit.
Patent Literature 1: Japanese Patent No. 4499381

### SUMMARY OF THE INVENTION

An object of the present disclosure is to obtain a spring mechanism capable of easily and precisely adjusting a spring constant by driving of a drive unit.

A spring mechanism according to one aspect of the present disclosure includes: a drive unit; a main body that houses the drive unit; a first structure that is disposed facing a first main surface of the main body and separated from the main body; and at least one first elastic member that has a first main surface side end movably connected to the first main surface and a first structure side end movably connected to the first structure, the at least one first elastic member including a non-circular cross-sectional shape, wherein the first elastic member rotates about a longitudinal axis by driving of the drive unit, thus allowing a repulsive force of the first elastic member with respect to a load component in a direction in which the first structure is pressed against the main body to be variably set.

### BRIEF DESCRIPTION OF THE DRAWINGS

FIG. 1 is a perspective view illustrating a configuration of a spring mechanism.

FIG. 2 is a side view illustrating a configuration of the spring mechanism.

FIGS. 3A and 3B are diagrams illustrating an operation of the spring mechanism.

FIGS. 4A and 4B are diagrams illustrating an operation of the spring mechanism.

FIGS. 5A and 5B are diagrams illustrating an operation of the spring mechanism.

FIG. 6 is a diagram schematically illustrating an application example of the spring mechanism.

FIG. 7 is a block diagram illustrating a control function for controlling the spring mechanism.

FIG. 8 is a diagram illustrating a modification in which one leaf spring is disposed.

FIG. 9 is a diagram illustrating a modification in which four leaf springs are arranged.

FIGS. 10A and 10B are diagrams illustrating a modification including a guide structure.

FIG. 11 is a perspective view illustrating a modification including a load sensor.

FIG. 12 is a block diagram illustrating a control function for controlling the spring mechanism.

FIG. 13 is a perspective view illustrating a modification including a coupling structure of a plurality of spring mechanisms.

FIG. 14 is a side view illustrating a modification including a coupling structure of a plurality of spring mechanisms.

FIG. 15 is a top view illustrating, in a simplified manner, a structure of a composite body in which three spring mechanisms are coupled in a longitudinal direction and a lateral direction.

FIG. 16 is a side view illustrating, in a simplified manner, a structure of a composite body in which three spring mechanisms are coupled in a longitudinal direction and a lateral direction.

### DETAILED DESCRIPTION

### Knowledge Underlying Present Disclosure

In furniture such as a bed or a chair used by a user, it is desirable that the hardness of the mattress or the seating surface can be adjusted according to the user's preference, physique, or the like.

Patent Literature 1 discloses a bed spring member capable of changing relative positions of a plurality of spring arms and a plurality of support arms by rotating a support having a plurality of support arms for supplementarily supporting the plurality of spring arms, thereby adjusting rigidity.

However, the spring member disclosed in Patent Literature 1 allows the user to manually rotate the support, and no consideration has been given to a mechanism for simply and precisely adjusting the spring constant by driving of the drive unit.

In order to solve such a problem, the present inventor has found that a main body that houses a drive unit and a structure that receives a load from a user are connected by an elastic member, and the elastic member is rotated about a longitudinal axis by driving of the drive unit to change a second moment of area, whereby a spring constant of a spring mechanism can be easily and precisely adjusted, and have arrived at the present disclosure.

Next, each aspect of the present disclosure will be described.

A spring mechanism according to a first aspect of the present disclosure includes: a drive unit; a main body that houses the drive unit; a first structure that is disposed facing a first main surface of the main body and separated from the main body; and at least one first elastic member that has a first main surface side end movably connected to the first main surface and a first structure side end movably connected to the first structure, the at least one first elastic member including a non-circular cross-sectional shape, wherein the first elastic member rotates about a longitudinal axis by driving of the drive unit, thus allowing a repulsive force of the first elastic member with respect to a load component in a direction in which the first structure is pressed against the main body to be variably set.

According to the first aspect, the first elastic member rotates about the longitudinal axis by driving of the drive unit, whereby the repulsive force of the first elastic member with respect to the load component in the direction in which the first structure is pressed against the main body can be variably set. As a result, the spring constant of the spring mechanism can be easily and precisely adjusted by driving of the drive unit.

In a spring mechanism according to a second aspect of the present disclosure, in the first aspect, the at least one first elastic member includes a plurality of first elastic members arranged spirally with respect to a center of the first main surface.

According to the second aspect, by providing the plurality of first elastic members, the load bearing capacity of the entire spring mechanism can be improved. Further, by arranging the plurality of first elastic members spirally with respect to the center of the first main surface, the force other than the force in the normal direction of the first main surface is canceled, so that the displacement of the first main surface in the direction other than the normal direction can be suppressed.

A spring mechanism according to a third aspect of the present disclosure further includes, in the first or second aspect: a second structure that is disposed to face a second main surface of the main body on a side opposite to the first main surface and separated from the main body; and at least one second elastic member that has a second main surface side end movably connected to the second main surface and a second structure side end movably connected to the second structure, the at least one second elastic member including a non-circular cross-sectional shape, wherein the second elastic member rotates about a longitudinal axis by driving of the drive unit, thus allowing a repulsive force of the second elastic member with respect to a load component in a direction in which the main body is pressed against the second structure to be variably set.

According to the third aspect, by providing the second elastic member in addition to the first elastic member, the load bearing capacity of the entire spring mechanism can be improved.

In a spring mechanism according to a fourth aspect of the present disclosure, in the third aspect, the at least one second elastic member includes a plurality of second elastic members arranged spirally with respect to a center of the second main surface.

According to the fourth aspect, by providing the plurality of second elastic members, the load bearing capacity of the entire spring mechanism can be further improved. Further, by arranging the plurality of second elastic members spirally with respect to the center of the second main surface, displacement of the second main surface in a direction other than the normal direction can be suppressed.

In a spring mechanism according to a fifth aspect of the present disclosure, in the third or fourth aspect, the first elastic member and the second elastic member are disposed mirror symmetrically with respect to the main body.

According to the fifth aspect, since the first elastic member and the second elastic member are disposed in mirror symmetry, the forces acting due to the load cancel each other in the first elastic member and the second elastic member. As a result, the main body is displaced when a load is applied, but the first structure and the second structure are not displaced, so that it is possible to avoid giving a sense of discomfort to the user.

A spring mechanism according to a sixth aspect of the present disclosure further includes, in any one of the first to fifth aspects: a guide structure that regulates a moving direction of the first structure such that the first structure moves toward the main body while maintaining a parallel relationship between the first structure and the main body with respect to a load on the first structure.

According to the sixth aspect, since the posture and the moving direction of the first structure are regulated by the guide structure, it is possible to avoid giving a sense of discomfort to the user.

A spring mechanism according to a seventh aspect of the present disclosure further includes, in any one of the first to sixth aspects, an electromagnetic brake that is housed in the main body and holds a rotational position of the first elastic member when driving of the drive unit is stopped.

According to the seventh aspect, by holding the rotational position of the first elastic member by the electromagnetic brake, power consumption of the drive unit can be reduced, and the drive unit can be protected from overload.

A spring mechanism according to an eighth aspect of the present disclosure further includes, in any one of the first to seventh aspects, a load sensor that detects a magnitude of a load on the first structure.

According to the eighth aspect, it is possible to appropriately control the driving of the drive unit or the electromagnetic brake according to the magnitude of the load on the first structure detected by the load sensor.

A spring mechanism according to a ninth aspect of the present disclosure further includes, in the eighth aspect, a control unit that controls driving of the drive unit based on load data input from the load sensor.

According to the ninth aspect, the spring constant of the spring mechanism or the settable range thereof can be appropriately adjusted according to the magnitude of the load on the first structure.

A spring mechanism according to a tenth aspect of the present disclosure further includes, in the eighth or ninth aspect, a control unit that controls driving of the electromagnetic brake based on load data input from the load sensor.

According to the tenth aspect, in a case where a load exceeding the allowable upper limit value is applied, the control unit turns on the electromagnetic brake, so that the drive unit can be protected from the overload.

### EMBODIMENTS OF PRESENT DISCLOSURE

Embodiments of the present disclosure will be described below in detail with reference to the drawings. Elements denoted with the same reference symbol in different drawings represent the same or corresponding elements. Constituent elements, placement positions of the constituent elements, connection forms, the order of operations, and the like shown in the following embodiments are one example, and are not intended to limit the present disclosure. The present disclosure is limited only by the claims. Therefore, a constituent element that is not described in an independent claim indicating the most generic concept of the present disclosure among constituent elements in the following embodiments is not necessarily required to achieve the object of the present disclosure, but the constituent element is described as constituting a more preferable form.

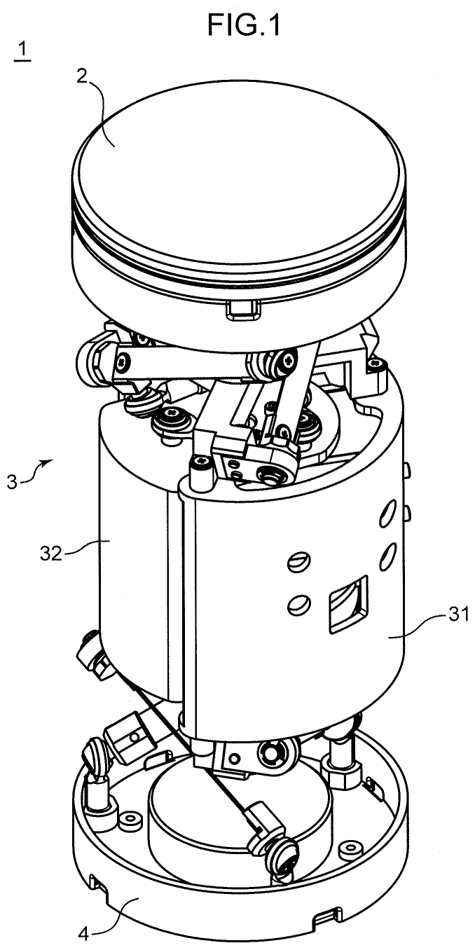

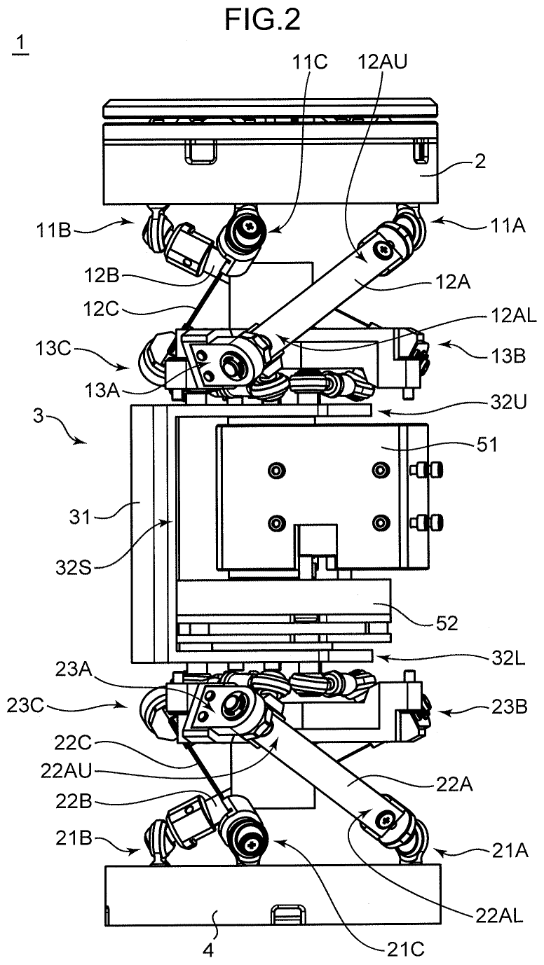

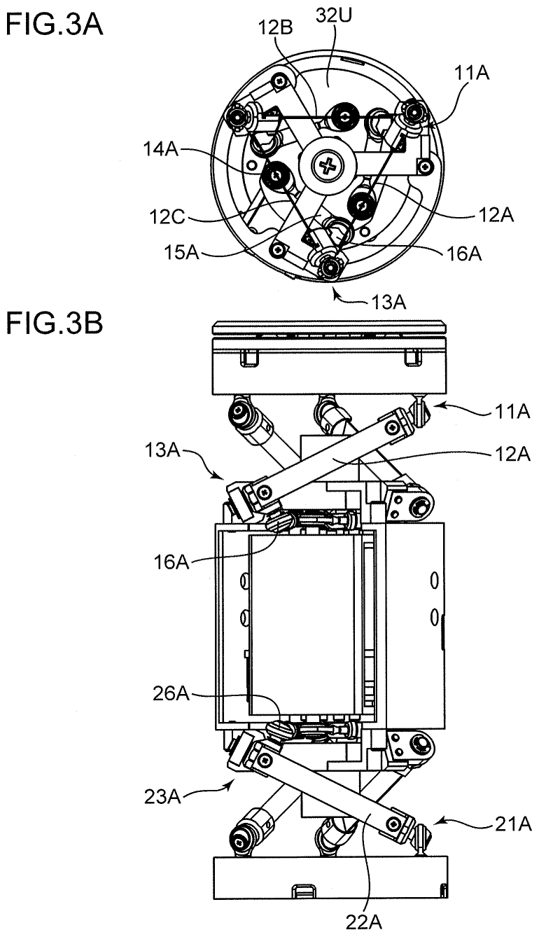

FIGS. 1 and 2 are a perspective view and a side view illustrating a configuration of a spring mechanism 1 according to an embodiment of the present disclosure. FIGS. 3 to 5 are diagrams illustrating the operation of the spring mechanism 1, in which (A) of each figure is a top view and (B) of each figure is a side view.

The spring mechanism 1 includes a main body 3 having a substantially cylindrical outer shape, and a first structure 2 and a second structure 4 having a substantially disk-shaped outer shape lower in height than the main body 3.

A motor 51 as an example of a drive unit and an electromagnetic brake 52 are housed inside the main body 3. The main body 3 includes a housing 31 and a movable member 32 having a substantially U-shaped cross-sectional shape. The movable member 32 includes an upper surface portion 32U constituting a part of the upper surface of the main body 3, a lower surface portion 32L constituting a part of the lower surface of the main body 3, and a side surface portion 32S coupling the upper surface portion 32U and the lower surface portion 32L. In the present embodiment, in the spring mechanism 1 illustrated in FIG. 1, the first structure 2 side with respect to the main body 3 is regarded as an upper side, and the second structure 4 side with respect to the main body 3 is regarded as a lower side. For example, a surface of the main body 3 on the first structure 2 side is referred to as an upper surface, and a surface of the main body 3 on the second structure 4 side is referred to as a lower surface. The upper surface of the main body 3 is referred to as a first main surface, and the lower surface of the main body 3 is referred to as a second main surface.

The motor 51 has a motor axis extending in the up-down direction, and the motor axis is connected to the lower surface portion 32L of the movable member 32 via the electromagnetic brake 52. By driving the motor 51 in a state where the electromagnetic brake 52 is turned off, the movable member 32 is rotationally driven around the motor axis. Further, by turning on the electromagnetic brake 52 in a state where the driving of the motor 51 is stopped, the rotational position of the movable member 32 is mechanically held.

The first structure 2 is disposed to face the first main surface of the main body 3 and to be separated from and parallel to the main body 3. The first structure 2 and the main body 3 are connected to each other by rod-shaped leaf springs 12A to 12C having the same length. The leaf springs 12A to 12C are arranged spirally (one-sheet hyperboloid shape) with respect to the center of the first main surface. In the present embodiment, a leaf spring having a rectangular cross-sectional shape orthogonal to the longitudinal direction is used as an example of the elastic member. It is preferable to use an elastic member having a rectangular cross section as described above because the spring constant of the spring mechanism 1 can be easily changed. However, the shape of the elastic member is not particularly limited as long as the spring constant of the spring mechanism 1 can be variably adjusted, and the cross-sectional shape orthogonal to the longitudinal direction may be circular, elliptical, H-shaped, or the like.

The leaf spring 12A has a first main surface side end 12AL movably connected to the first main surface of the main body 3 by a bearing member 13A, and a first structure side end 12AU movably connected to the lower surface of the first structure 2 by a bearing member 11A. Here, “movably connected” indicates a state in which the bearing member 13A and the bearing member 11A are used as contacts, and the leaf spring 12A is connected to the main body 3 and the first structure 2 so as to be operable. The operation of the leaf spring 12A includes an operation in which the leaf spring 12A rotates about the longitudinal axis of the leaf spring 12A, an operation in which the installation angle of the leaf spring 12A with respect to the main body 3 or the first structure 2 changes, and the like. The bearing member 11A is fixed to the first structure 2, and the bearing member 13A is fixed to the housing 31. When projected onto the first main surface, the installation location of the bearing member 11A and the installation location of the bearing member 13A do not coincide with each other.

Similarly, the leaf spring 12B has a first main surface side end movably connected to the first main surface of the main body 3 by a bearing member 13B, and a first structure side end movably connected to the lower surface of the first structure 2 by a bearing member 11B. The bearing member 11B is fixed to the first structure 2, and the bearing member 13B is fixed to the housing 31. When projected onto the first main surface, the installation location of the bearing member 11B and the installation location of the bearing member 13B do not coincide with each other.

Similarly, the leaf spring 12C has a first main surface side end movably connected to the first main surface of the main body 3 by a bearing member 13C, and a first structure side end movably connected to the lower surface of the first structure 2 by a bearing member 11C. The bearing member 11C is fixed to the first structure 2, and the bearing member 13C is fixed to the housing 31. When projected onto the first main surface, the installation location of the bearing member 11C and the installation location of the bearing member 13C do not coincide with each other.

The second structure 4 is disposed to face the second main surface of the main body 3 and to be separated from and parallel to the main body 3. The second structure 4 and the main body 3 are connected to each other by rod-shaped leaf springs 22A to 22C having the same length. The leaf springs 22A to 22C are arranged spirally (one-sheet hyperboloid shape) with respect to the center of the second main surface.

The leaf spring 22A has a second main surface side end 22AU movably connected to the second main surface of the main body 3 by a bearing member 23A, and a second structure side end 22AL movably connected to the upper surface of the second structure 4 by a bearing member 21A. Here, “movably connected” indicates a state in which the bearing member 23A and the bearing member 21A are used as contacts, and the leaf spring 22A is connected to the main body 3 and the second structure 4 so as to be operable. The operation of the leaf spring 22A includes an operation in which the leaf spring 22A rotates about the longitudinal axis of the leaf spring 22A, an operation in which the installation angle of the leaf spring 22A with respect to the main body 3 or the second structure 4 changes, and the like. The bearing member 21A is fixed to the second structure 4, and the bearing member 23A is fixed to the housing 31. When projected onto the second main surface, the installation location of the bearing member 21A and the installation location of the bearing member 23A do not coincide with each other.

Similarly, the leaf spring 22B has a second main surface side end movably connected to the second main surface of the main body 3 by a bearing member 23B, and a second structure side end movably connected to the upper surface of the second structure 4 by a bearing member 21B. The bearing member 21B is fixed to the second structure 4, and the bearing member 23B is fixed to the housing 31. When projected onto the second main surface, the installation location of the bearing member 21B and the installation location of the bearing member 23B do not coincide with each other.

Similarly, the leaf spring 22C has a second main surface side end movably connected to the second main surface of the main body 3 by a bearing member 23C, and a second structure side end movably connected to the upper surface of the second structure 4 by a bearing member 21C. The bearing member 21C is fixed to the second structure 4, and the bearing member 23C is fixed to the housing 31. When projected onto the second main surface, the installation location of the bearing member 21C and the installation location of the bearing member 23C do not coincide with each other.

The leaf springs 12A to 12C and the leaf springs 22A to 22C are disposed mirror-symmetrically with respect to the main body 3. That is, when projected onto the first main surface or the second main surface, the installation location of the bearing member 11A and the installation location of the bearing member 21A are the same, the installation location of the bearing member 13A and the installation location of the bearing member 23A are the same, and the length of the leaf spring 12A and the length of the leaf spring 22A are the same. Similarly, when projected onto the first main surface or the second main surface, the installation location of the bearing member 11B and the installation location of the bearing member 21B are the same, the installation location of the bearing member 13B and the installation location of the bearing member 23B are the same, and the length of the leaf spring 12B and the length of the leaf spring 22B are the same. Similarly, when projected onto the first main surface or the second main surface, the installation location of the bearing member 11C and the installation location of the bearing member 21C are the same, the installation location of the bearing member 13C and the installation location of the bearing member 23C are the same, and the length of the leaf spring 12C and the length of the leaf spring 22C are the same.

By driving the motor 51 in a state where the electromagnetic brake 52 is turned off, the movable member 32 is rotationally driven around the motor axis. The operation of the leaf spring 12A accompanying this will be described with reference to FIGS. 3 to 5. Since the operations of the other leaf springs 12B, 12C, and 22A to 22C are similar to those described above, redundant description is omitted.

A connection member 14A is fixed to the upper surface portion 32U of the movable member 32, and one end portion of a link mechanism 15A is connected to the connection member 14A. The other end portion of the link mechanism 15A is connected to the leaf spring 12A by a connection member 16A in the vicinity of the bearing member 13A.

When the movable member 32 rotates by driving of the motor 51, the connection member 14A fixed to the upper surface portion 32U of the movable member 32 also rotates. Then, when the connection member 16A is pushed or pulled by the link mechanism 15A connected to the connection member 14A, the leaf spring 12A rotates about its longitudinal axis. Note that the motor 51 is an example of a drive unit, and the drive unit may be of any type as long as it can generate a driving force for rotationally driving an elastic member such as a leaf spring and transmit the driving force to the elastic member via a link mechanism. The drive unit may be an electric actuator such as the motor 51, or may be a mechanism or a structure that manually rotationally drives the elastic member.

FIG. 3 illustrates a state in which the shapes of the leaf springs 12A to 12C and 22A to 22C are set to be thinnest when viewed from above and thickest when viewed from the side by driving of the motor 51. As described above, in a state where the shape of each leaf spring is thinnest when viewed from above, the second moment of area regarding the direction in which the load is applied is the largest. Then, the second moment of area of the leaf springs 12A to 12C and 22A to 22C in the up-down direction becomes a maximum value, and the repulsive force of the leaf springs 12A to 12C and 22A to 22C with respect to the load component in the up-down direction becomes a maximum value. Therefore, the spring constant of the spring mechanism 1 is also set to a maximum value.

### (Basic Rule Regarding Design of Spring Mechanism Using Leaf Spring)

A structure for designing a spring mechanism using a leaf spring will be described. First, it is preferable to use a plurality of leaf springs as the leaf springs. As a result, in a case where pressing is applied to the first structure 2, smooth displacement with respect to the first structure 2 can be realized by this pressing.

In addition, in a case where a plurality of leaf springs are used, the leaf springs are preferably arranged such that fulcrums (bearings) of the plurality of leaf springs become vertices of a regular polygon when the spring mechanism 1 is viewed from above. As described above, by using the plurality of leaf springs and arranging the fulcrums of the leaf springs at the vertices of the regular polygon, in a case where pressing is applied to the upper surface of the first structure 2, the fulcrums are displaced according to the pressure distribution on the upper surface, so that the first structure 2 can be smoothly displaced according to the pressure distribution. The pressure distribution changes depending on the shape or pressed state of the pressed object applied to the upper surface of the first structure 2. In addition, the plurality of leaf springs may be arranged radially when the spring mechanism 1 is viewed from above.

### (Length of Leaf Spring)

The longer the length of each leaf spring, the more preferably the deflection amount can be secured. However, as the length of each leaf spring increases, the overall size of the spring mechanism 1 increases. Therefore, the length of the leaf spring may be appropriately adjusted according to a desired size of the spring mechanism 1.

### (Best Mode of Number and Arrangement of Leaf Springs)

In the spring mechanism 1, from the viewpoint of securing the deflection amount of the leaf spring and smoothly displacing the first structure 2 by the displacement of the fulcrum according to the pressure distribution, it is preferable to use three leaf springs and arrange the leaf springs so as to have an equilateral triangle when viewed from above the first structure 2. In the case of an equilateral triangle, the lengths of the leaf springs are the same.

### (Best Mode of Orientation and Inclination of Leaf Spring)

The leaf spring is preferably disposed in an orientation in which the longitudinal direction thereof is perpendicular to the pressing direction to the spring mechanism 1. As a result, the pressing force to the spring mechanism 1 and the bending stress to the leaf spring become equal, and as a result, the deflection amount of the leaf spring can be secured.

On the other hand, as described above, in a case where the leaf springs are arranged such that the longitudinal direction thereof is perpendicular to the pressing direction to the spring mechanism 1 and the plurality of leaf springs are arranged in a regular polygon, if the length of each leaf spring is made as long as possible in order to secure the deflection amount of each leaf spring, the bearing connected to the first structure 2 and the bearing connected to the main body 3 of the adjacent leaf spring easily interfere with each other. For example, the bearing member 11C and the bearing member 13A or the bearing member 11A and the bearing member 13B in FIG. 2 easily interfere with each other. Therefore, under such conditions, from the viewpoint of securing the deflection amount of each leaf spring, it is preferable to incline the leaf spring from the direction in which the longitudinal direction is perpendicular to the pressing direction to the spring mechanism 1 toward the pressing direction.

When the leaf spring is inclined, it is preferable to adjust the inclination angle so that the adjacent bearings do not interfere with each other. In both (a) a state in which the plurality of leaf springs are arranged in a regular polygon and there is no deflection and (b) a state in which there is deflection within a range in which the deflection of the leaf spring itself is elastically deformed, the inclination angle of the leaf spring is adjusted so that the adjacent bearings do not interfere with each other.

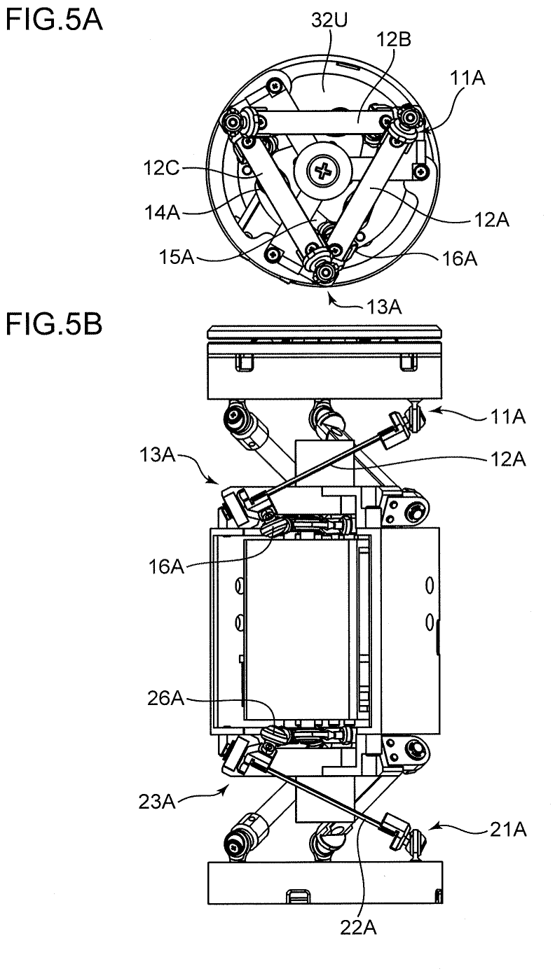

FIG. 5 illustrates a state in which the shapes of the leaf springs 12A to 12C and 22A to 22C are set to be thickest when viewed from above and thinnest when viewed from the side by driving of the motor 51. In this state, the second moment of area of the leaf springs 12A to 12C and 22A to 22C in the up-down direction becomes a minimum value, and the repulsive force of the leaf springs 12A to 12C and 22A to 22C with respect to the load component in the up-down direction becomes a minimum value. Therefore, the spring constant of the spring mechanism 1 is also set to a minimum value.

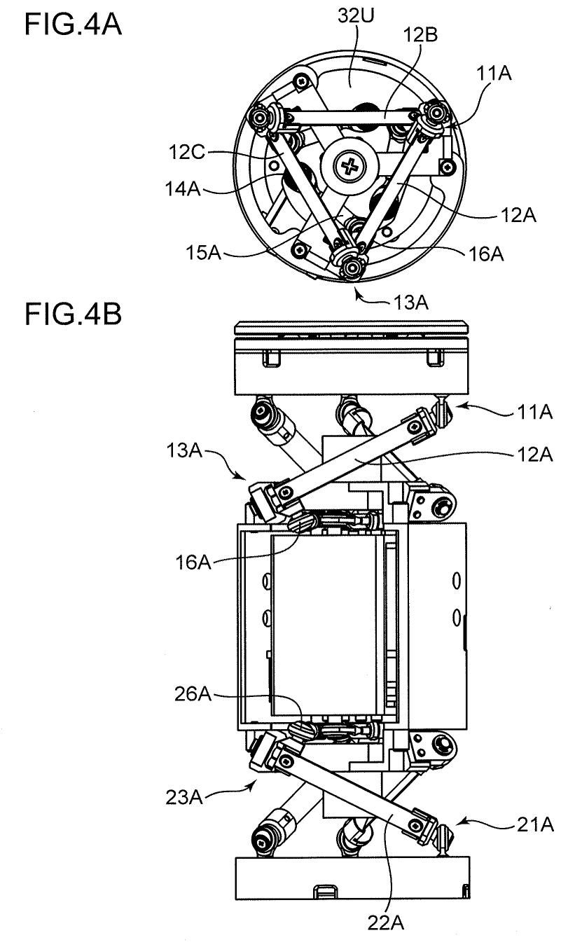

FIG. 4 illustrates an intermediate state between FIGS. 3 and 5. In this state, the second moment of area of the leaf springs 12A to 12C and 22A to 22C in the up-down direction becomes the intermediate value, and the repulsive force of the leaf springs 12A to 12C and 22A to 22C with respect to the load component in the up-down direction becomes the intermediate value. Therefore, the spring constant of the spring mechanism 1 is also set to the intermediate value. By controlling the rotation of the movable member 32 steplessly between the state of FIG. 3 and the state of FIG. 5 by driving of the motor 51, the spring constant of the spring mechanism 1 can be arbitrarily and minutely adjusted between a maximum value and a minimum value.

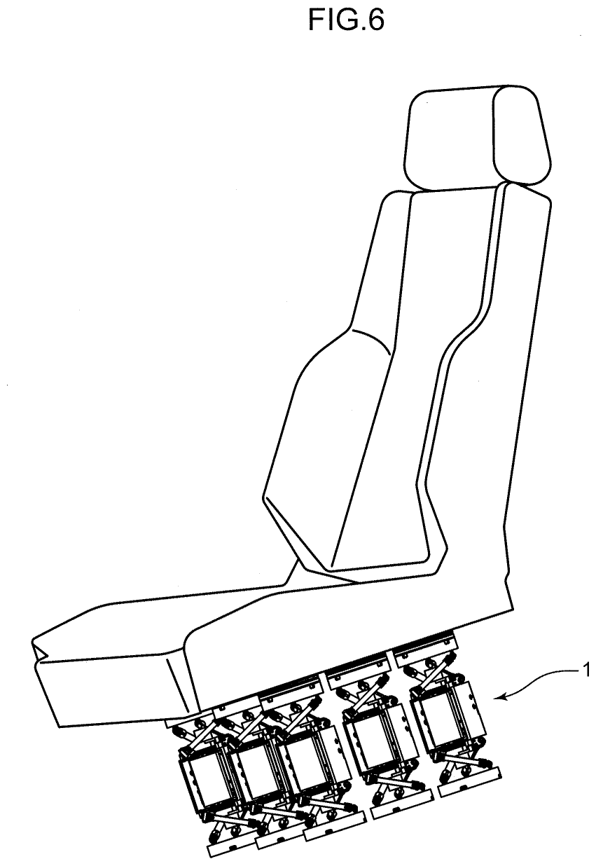

FIG. 6 is a diagram schematically illustrating an application example of the spring mechanism 1 according to the present embodiment. The plurality of spring mechanisms 1 are arranged side by side under the seating surface of the chair. The user who uses the chair can adjust the hardness of the seating surface according to his/her preference by arbitrarily setting the spring constant of each spring mechanism 1 by driving of the motor 51. In addition, the spring mechanism 1 according to the present embodiment is also applicable to a bed mattress. The plurality of spring mechanisms 1 are arranged side by side under the mattress, and the user who uses the bed can adjust the hardness of the mattress according to his/her preference by arbitrarily setting the spring constant of each spring mechanism 1 by driving of the motor 51. Note that the application target of the spring mechanism 1 according to the present embodiment is not limited to a chair or a bed, and the spring mechanism 1 can be applied to any furniture, device, or the like in which it is beneficial to variably set the spring constant.

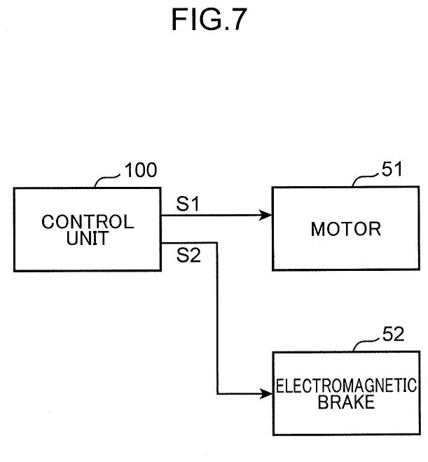

FIG. 7 is a block diagram illustrating a control function for controlling the spring mechanism 1. A control unit 100 such as a microcontroller controls driving of the motor 51 by a control signal S1, and controls driving of the electromagnetic brake 52 by a control signal S2. The control unit 100 drives the motor 51 by the control signal S1 in a state where the electromagnetic brake 52 is turned off by the control signal S2, thereby rotationally driving the movable member 32 about the motor axis. In addition, the control unit 100 mechanically holds the rotational position of the movable member 32 by turning on the electromagnetic brake 52 by the control signal S2 in a state where the driving of the motor 51 is stopped by the control signal S1. In a case where the plurality of spring mechanisms 1 are mounted as illustrated in FIG. 6, one control unit 100 that integrally controls the plurality of spring mechanisms 1 may be mounted, or each spring mechanism 1 may individually include the control unit 100.

In the spring mechanism 1 according to the present embodiment, the leaf springs 12A to 12C (first rod-shaped elastic members) rotate about the longitudinal axis by driving of the motor 51, whereby the repulsive force of the leaf springs 12A to 12C with respect to the load component in the direction of pressing the first structure 2 toward the main body 3 can be variably set. As a result, the spring constant of the spring mechanism 1 can be easily and precisely adjusted by driving of the motor 51.

In addition, by providing the plurality of leaf springs 12A to 12C, the load bearing capacity of the entire spring mechanism 1 can be improved. Further, by arranging the plurality of leaf springs 12A to 12C spirally with respect to the center of the first main surface, displacement of the first main surface in a direction other than the normal direction can be suppressed.

In addition, by providing the leaf springs 22A to 22C (second rod-shaped elastic members) in addition to the leaf springs 12A to 12C, it is possible to improve the load bearing capacity of the entire spring mechanism 1.

In addition, by providing the plurality of leaf springs 22A to 22C, the load bearing capacity of the entire spring mechanism 1 can be further improved. Further, by arranging the plurality of leaf springs 22A to 22C spirally with respect to the center of the second main surface, displacement of the second main surface in a direction other than the normal direction can be suppressed.

In addition, since the leaf springs 12A to 12C and the leaf springs 22A to 22C are disposed in mirror symmetry, the forces acting due to the loads cancel each other by the leaf springs 12A to 12C and the leaf springs 22A to 22C. As a result, the main body 3 is displaced when a load is applied, but the first structure 2 and the second structure 4 are not displaced, so that it is possible to avoid giving a sense of discomfort to the user.

In addition, by holding the rotational positions of the leaf springs 12A to 12C and 22A to 22C by the electromagnetic brake 52, the power consumption of the motor 51 can be reduced, and the motor 51 can be protected from overload.

### First Modification

In the above embodiment, the leaf springs 22A to 22C and the second structure 4 may be omitted. The leaf springs 12A to 12C and 22A to 22C are not limited to the thin plate shape, and may have any shape as long as the shape at least partially includes a non-circular cross-sectional shape.

### Second Modification

In the above embodiment, the three leaf springs 12A to 12C are disposed between the first main surface of the main body 3 and the first structure 2, but the number of leaf springs may be one or more.

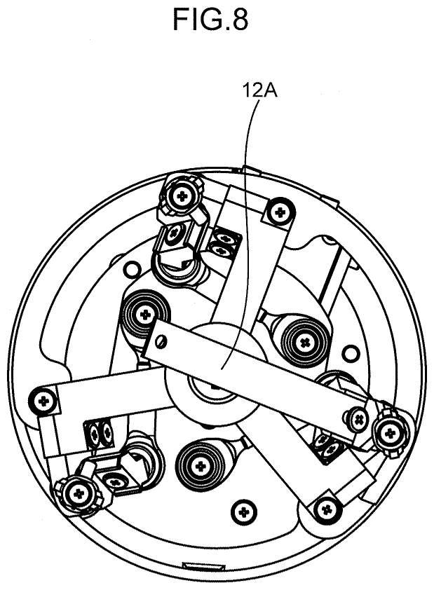

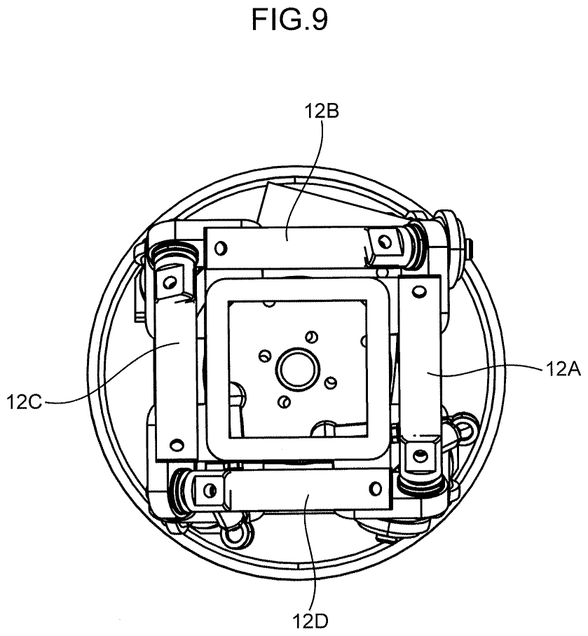

FIG. 8 is a diagram illustrating a modification in which one leaf spring 12A is disposed, and FIG. 9 is a diagram illustrating a modification in which four leaf springs 12A to 12D are disposed. The number of leaf springs is set to an optimum value according to a desired load bearing capacity, a size of the spring mechanism 1, or the like.

### Third Modification

A guide structure 61 for regulating the moving direction of the first structure 2 in the up-down direction against a load on the first structure 2 from an arbitrary direction may be further provided.

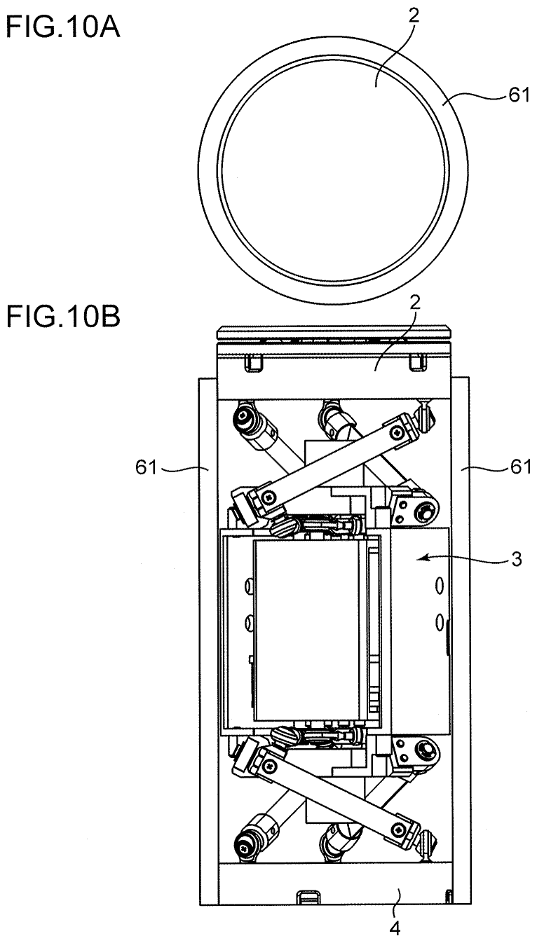

FIG. 10 is a diagram illustrating a modification including the guide structure 61. In the above embodiment, each of the upper surface shapes of the first structure 2, the main body 3, and the second structure 4 is a perfect circle. Therefore, in the modification illustrated in FIG. 10, a cylindrical guide structure 61 having a diameter corresponding to the perfect circle is disposed along the outer peripheral surfaces of the first structure 2, the main body 3, and the second structure 4.

According to the present modification, the guide structure 61 regulates the moving direction of the first structure 2 such that the first structure 2 moves toward the main body 3 while maintaining the parallel relationship between the first structure 2 and the main body 3 with respect to the load on the first structure 2. In this manner, since the posture and the moving direction of the first structure 2 are regulated by the guide structure 61, it is possible to avoid giving a sense of discomfort to the user.

### Fourth Modification

In the above embodiment, a detection member that detects deformation or displacement of the first structure 2 may be used. As the detection member, for example, a load sensor 65 that detects the magnitude of the load on the first structure 2 may be used. As the load sensor 65, for example, a strain gauge that detects strain of the first structure 2 may be used. Hereinafter, a case where four load sensors 65 are used will be described.

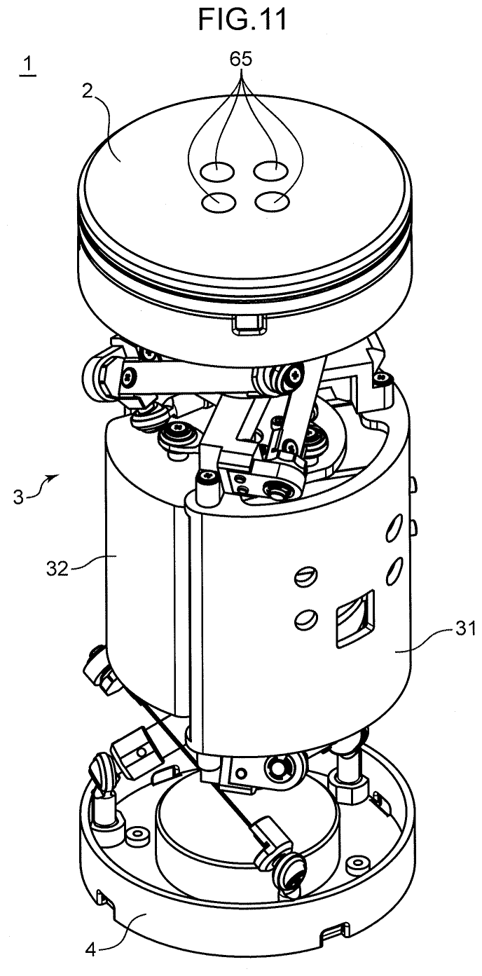

FIG. 11 is a perspective view illustrating a modification in which the load sensor 65 is provided in the first structure 2. Four load sensors 65 are disposed in the upper surface of the first structure 2. The load sensor 65 is, for example, a strain gauge. In the example of FIG. 11, four load sensors 65 are disposed, but the number of load sensors 65 may be one or more. The load sensor 65 is preferably disposed in parallel with the upper surface (main surface) of the first structure 2 in order to measure the load applied to the entire leaf springs 12A to 12C and 22A to 22C, which are elastic members. As long as this condition is satisfied, it may not be in the upper surface of the first structure 2, and may be disposed in the housing 31, for example. The load sensor 65 may be disposed at the bases of the bearing members 11A to 11C and 21A to 21C, and the load directly applied to the leaf springs 12A to 12C and 22A to 22C may be measured. When the load sensor 65 is disposed at the bases of the bearing members 11A to 11C and 21A to 21C in this manner, it is also possible to measure the load balance applied to the leaf springs 12A to 12C and 22A to 22C.

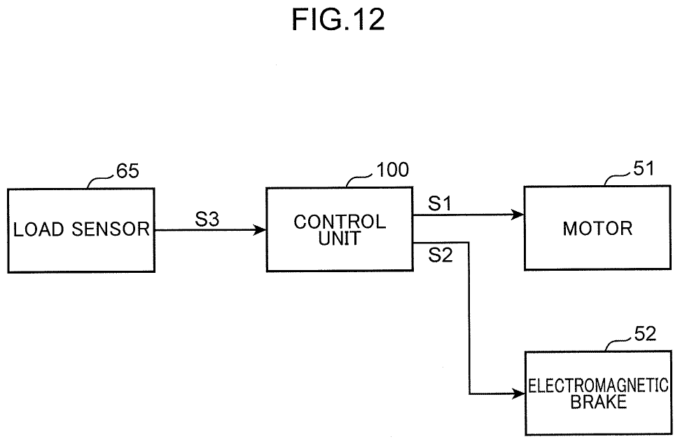

FIG. 12 is a block diagram illustrating a control function for controlling the spring mechanism 1. The control unit 100 controls driving of the motor 51 by control signal S1 based on load data S3 input from the load sensor 65, and controls driving of the electromagnetic brake 52 by the control signal S2.

For example, the control unit 100 appropriately adjusts the spring constant of the spring mechanism 1 according to the magnitude of the load on the first structure 2 indicated by the load data S3. Alternatively, the control unit 100 appropriately adjusts the settable range (upper limit value and lower limit value) of the spring constant according to the magnitude of the load on the first structure 2 indicated by the load data S3. The magnitude of the load indicated by the load data S3 may be an instantaneous value, an average value in a predetermined sampling period, or a maximum value in a predetermined sampling period.

For example, the control unit 100 turns on the electromagnetic brake 52 by the control signal S2 in a case where a load exceeding the allowable upper limit value is applied according to the magnitude of the load on the first structure 2 indicated by the load data S3. As a result, the motor 51 can be protected from an overload exceeding the allowable upper limit value.

### Fifth Modification

The spring mechanism 1 according to the present disclosure can also be used as a “composite body” in which a plurality of spring mechanisms 1 are coupled in the up-down direction (longitudinal direction) and/or the left-right direction (lateral direction) via a coupling portion. The coupling portion is a member for coupling the spring mechanisms 1 to each other, and includes, for example, a screw. Such a composite body in which the plurality of spring mechanisms 1 are coupled is a structure in which the entire composite body is moved by moving the leaf spring installed in each spring mechanism 1.

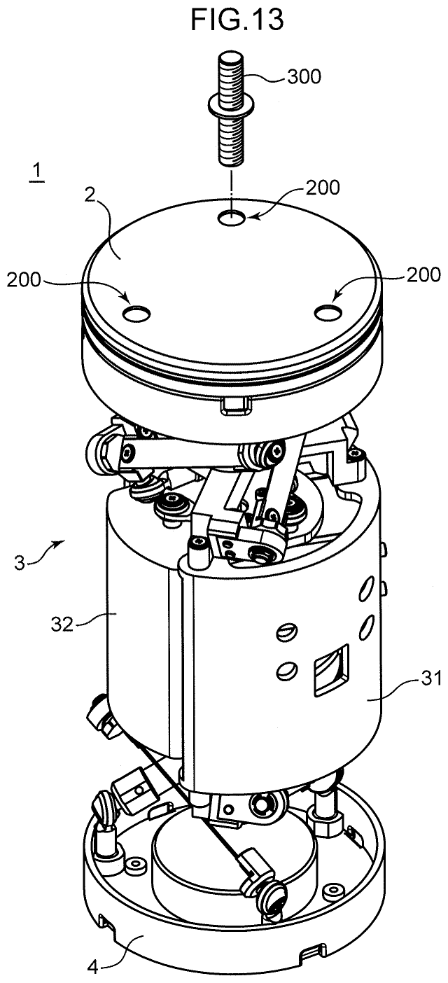

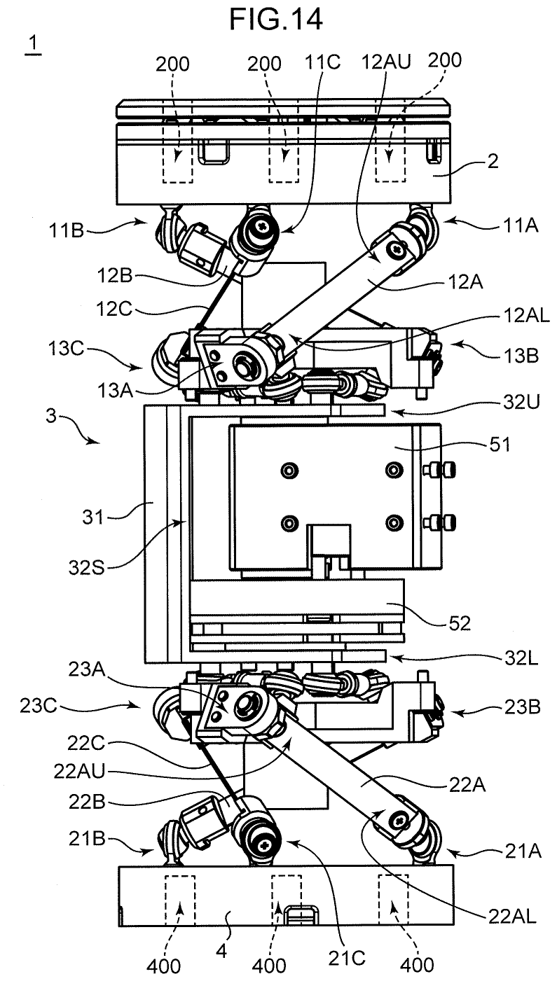

An example in which the plurality of spring mechanisms 1 are coupled in the up-down direction via screws will be described. FIGS. 13 and 14 are a perspective view and a side view illustrating a modification including a coupling structure of a plurality of spring mechanisms 1. A plurality of screw holes 200 are formed at predetermined locations on the upper surface of the first structure 2, and a plurality of screw holes 400 are formed at locations corresponding to the screw holes 200 on the lower surface of the second structure 4. By inserting a screw 300 screwed into the screw holes 200 and 400 into the screw hole 200 of one spring mechanism 1 and the screw hole 400 of the other spring mechanism 1, one spring mechanism 1 and the other spring mechanism 1 can be coupled in the up-down direction. As a result, an adjustment range of the load bearing capacity and the spring constant in the up-down direction is expanded. In addition, the overall height of the composite body of the plurality of spring mechanisms 1 can be adjusted by adjusting the insertion amount of the screw 300 into the screw holes 200 and 400. Here, it is desirable to form the plurality of screw holes 200 and 400 point-symmetrically with respect to the central axis of the spring mechanism 1 in order to make the load uniform. However, the number and formation locations of the screw holes 200 and 400 are not particularly limited, and may be non-point-symmetric.

The screw hole into which the screw 300 is inserted is not limited to the concentric screw hole 200 as illustrated in FIG. 13. For example, a groove shape extending along the circumferential direction of the first structure 2 is provided on the upper surface of the first structure 2, and the screws 300 are variably combined along the groove shape, so that it is possible to adjust the direction, angle, or the like when coupling the plurality of spring mechanisms 1.

Further, the bearing member may be configured to move along a screw hole or a groove shape. According to such a configuration, since the bearing member moves along the screw hole or the groove shape in conjunction with the movement of the leaf spring, the movable range of the spring mechanism 1 can be expanded. In addition, when the plurality of spring mechanisms 1 are combined, it is possible to obtain a composite body of the spring mechanisms 1 while the forces of the spring mechanisms 1 are transmitted to each other along the screw hole or the groove shape. Instead of screwing with a screw, the plurality of spring mechanisms 1 may be coupled in the up-down direction by fitting in an uneven shape or the like.

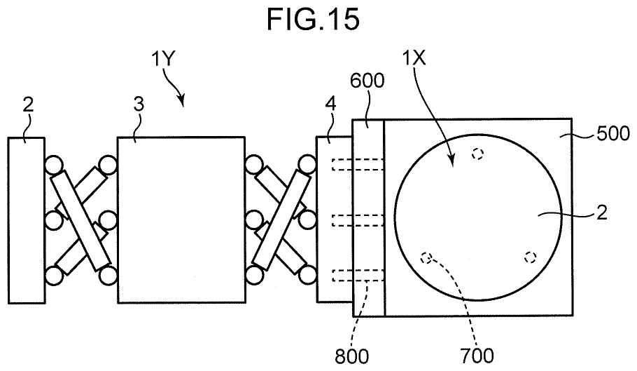

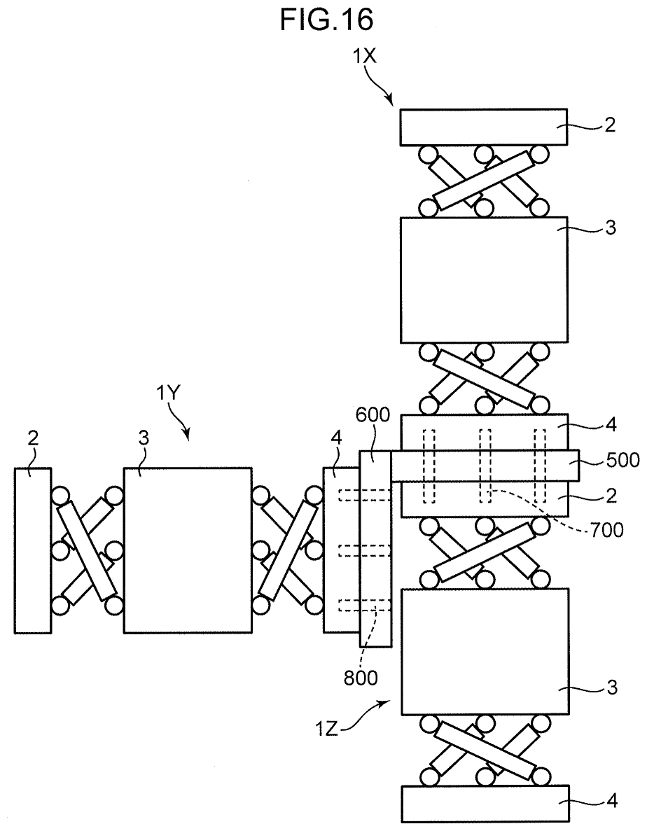

FIGS. 15 and 16 are a top view and a side view illustrating, in a simplified manner, a structure of a composite body in which three spring mechanisms 1X, 1Y, and 1Z are coupled in the longitudinal direction and the lateral direction. The spring mechanism 1X and the spring mechanism 1Z are vertically coupled to each other via a screw 700 inserted through a screw hole 400 provided in the second structure 4 of the spring mechanism 1X, a screw hole provided in a first intermediate 500 in the horizontal posture, and a screw hole 200 provided in the first structure 2 of the spring mechanism 1Z. In addition, the spring mechanism 1Y and the spring mechanism 1Z are laterally coupled via a screw 800 inserted through a screw hole 400 provided in the second structure 4 of the spring mechanism 1Y and a screw hole provided in a second intermediate 600 in the vertical posture fixed to the first intermediate 500. The first intermediate 500 and the second intermediate 600 are, for example, metal plates. By appropriately adjusting the movement of each of the spring mechanisms 1X, 1Y, and 1Z, it is possible to move each of the spring mechanisms 1X, 1Y, and 1Z while exerting spring characteristics as the entire composite body. Note that a composite body may be configured by coupled four or more spring mechanisms 1 in the longitudinal direction and the lateral direction.

The present disclosure is particularly useful for application to any furniture, device, or the like in which it is beneficial to variably set the spring constant.

1. A spring mechanism comprising:
a drive unit;
a main body that houses the drive unit;
a first structure that is disposed facing a first main surface of the main body and separated from the main body; and
at least one first elastic member that has a first main surface side end movably connected to the first main surface and a first structure side end movably connected to the first structure, the at least one first elastic member including a non-circular cross-sectional shape,
wherein the first elastic member rotates about a longitudinal axis by driving of the drive unit, thus allowing a repulsive force of the first elastic member with respect to a load component in a direction in which the first structure is pressed against the main body to be variably set.

2. The spring mechanism according to claim 1, wherein the at least one first elastic member includes a plurality of first elastic members arranged spirally with respect to a center of the first main surface.

3. The spring mechanism according to claim 1, further comprising:
a second structure that is disposed to face a second main surface of the main body on a side opposite to the first main surface and separated from the main body; and
at least one second elastic member that has a second main surface side end movably connected to the second main surface and a second structure side end movably connected to the second structure, the at least one second elastic member including a non-circular cross-sectional shape,
wherein the second elastic member rotates about a longitudinal axis by driving of the drive unit, thus allowing a repulsive force of the second elastic member with respect to a load component in a direction in which the main body is pressed against the second structure to be variably set.

4. The spring mechanism according to claim 3, wherein the at least one second elastic member includes a plurality of second elastic members arranged spirally with respect to a center of the second main surface.

5. The spring mechanism according to claim 3, wherein the first elastic member and the second elastic member are disposed mirror-symmetrically with respect to the main body.

6. The spring mechanism according to claim 1, further comprising a guide structure that regulates a moving direction of the first structure such that the first structure moves toward the main body while maintaining a parallel relationship between the first structure and the main body with respect to a load on the first structure.

7. The spring mechanism according to claim 1, further comprising an electromagnetic brake that is housed in the main body and holds a rotational position of the first elastic member when driving of the drive unit is stopped.

8. The spring mechanism according to claim 1, further comprising a load sensor that detects a magnitude of a load on the first structure.

9. The spring mechanism according to claim 8, further comprising a control unit that controls driving of the drive unit based on load data input from the load sensor.

10. The spring mechanism according to claim 8, further comprising a control unit that controls driving of the electromagnetic brake based on load data input from the load sensor.
